(19) United States
(12) Patent Application Publication
(10) Pub. No.: US 2002/0094190 A1
(43) Pub. Date: Jul. 18, 2002

(54) Video image playback method in a digital TV image transmitting and receiving system

(76) Inventor: Muneomi Katayama, Tokyo (JP)

Correspondence Address: REED SMITH HAZEL & THOMAS LLP, Suite 1400, 3110 Fairview Park Drive, Falls Church, VA, 22042, US

(21) Appl. No.: 09/984,421

(22) Filed: Oct. 30, 2001

(30) Foreign Application Priority Data
Nov. 1, 2000 (JP) 2000-372122

(51) Int. Cl. H04N 9/80

(52) U.S. Cl. 386/29

(57) ABSTRACT

An object of the present invention is to provide a video image playback method in a novel digital TV image transmitting and receiving system which reproduces an already broadcast video image and/or sound on the same channel by separating the video image and a data linked therewith.

[Construction]

A buffer system having a function of successively recording and erasing broadcast video images and sounds linked therewith by the second or by the minute while continuing an actual real-time broadcasting is provided in a network circuit. A video image playback method in a digital TV image transmitting and receiving system can reproduce already broadcast video images and/or sounds by operating the buffer system.

### DETAILED DESCRIPTION OF THE PRESENT INVENTION

1. Technical Field of the Invention

The present invention relates to a digital transmitting system with built-in contents using a database and particularly to a video image playback method in a digital TV image transmitting and receiving system with built-in contents using a database in a TV broadcasting.

2. Description of Prior Art

In a usual TV broadcasting, for example, sports broadcasting, video signals and sound signals are transmitted using microwaves from a broadcasting site to a TV station via a relay car, and further transmitted to viewers after necessary data are superimposed thereon in a master room at the TV station. Video images and data are constantly displayed on a screen regardless of whether the viewers like it or not. Generally, the viewers cannot choose the video images and data.

In view of the above, an object of the present invention is to propose a video image playback method in a novel digital TV image transmitting and receiving system for reproducing and transmitting a video image and/or a sound already broadcast on the same channel by separating the video image and a data linked therewith.

Another object of the present invention is to enable a viewer to simultaneously display on the same TV display in real time.

### SUMMARY OF THE PRESENT INVENTION

A video image playback method in a digital TV image transmitting and receiving system according to the present invention is characterized in that a buffer system having a function of successively recording and erasing broadcast video images and sounds linked therewith by the second or by the minute while continuing an actual real-time broadcasting is provided in a network circuit. As a result, an already broadcast video image and/or sound can be reproduced by operating the buffer system.

Specifically, particularly in a real-time broadcasting, scenes most wanted to see, for example, the form and facial expression of a player when the player hits a home run in a baseball game or the player shoots for a goal in a soccer game or the form and facial expression of a jockey when he wins by a nose, are often missed. In view of this situation, it is made possible to reproduce such exciting scenes themselves as video images or reproduce them on two or more screens without overlapping the video image being broadcast in real time.

Further, by operating the buffer system, the video image presently being broadcast and the already broadcast video image can be reproduced on two screens together with the sounds.

In other words, a viewer can enjoy watching the video image broadcast in the past on the same display while watching a real-time broadcasting.

### PREFERRED EMBODIMENTS OF THE PRESENT INVENTION

The present invention concerns a digital transmitting system for transmitting video images and data linked therewith on the same channel by separating them. This system at least transmits digitized video images and data linked therewith on the same channel by separating them and displays a desired video image and a data linked therewith upon a request from a receiver, and comprises a buffer system for temporarily storing digitized data (contents) of pieces of past information broadcast several seconds or several minutes before a video image presently being broadcast, a multiplexing/modulating device transmitting via a ground wave or a satellite wave, a demultiplexing/demodulating device for demultiplexing and demodulating the data signal transmitted on one usual TV channel via the ground wave or the satellite wave from the multiplexing/modulating device, and a receiver to which an output from the demultiplexing/demodulating device is inputted and which is connected with the buffer system.

[Embodiment 1]

Hereinafter, embodiments are described. Identified by (1), (2) and (3) are a broadcasting station, a PC of a viewer and a network system of a real-time live broadcasting, respectively. Identified by (4) is a backup system for storing video images and sound signals from the broadcasting station for a predetermined time (by the second or by the minute). An operator of the PC (viewer) can freely access to the stored information by means of a remote controller (5).

[Embodiment 2]

Now, reception of a baseball game broadcasting by the receiver (2) realized by the PC is described for the sake of convenience. As shown in FIG. 2, video images and sounds collected by a relay system (6) are transmitted to the PC (2) of the viewer via the broadcasting station (1) as in a usual broadcasting.

If one player hits a home run while the viewer is absent for a short period of time, the viewer cannot watch the relating video images and sounds. This is because a video image presently being displayed is a video image several seconds or several minutes after that of the home run.

As a matter of course, the viewer wants to reproduce this player's form and reaction and his fans' cheering encouragement when he hit a home rum.

Accordingly, the viewer calls and activates the buffer system (4). Since video images and sounds several seconds or several minutes before those presently being displayed are recorded in the buffer system as mentioned above, the video image (9) several seconds or several minutes ago can be displayed on the PC (2) of the viewer in a still or animated manner. Therefore, the player's form and reaction and so-called ,,clamor” from the audience when he hit a home run, which the viewer would have wanted to see, can be reproduced while the real-time broadcasting is being made.

If the video image several seconds or several minutes ago is displayed in parallel with the video image presently being broadcast on a display of the same PC (2) without being overlapped as shown by reference numerals (7) and (8) in FIG. 2, there is no possibility of missing a presently broadcast video image while viewing the past video image.

In the present invention, by providing the buffer system in the real-time live broadcasting, the digitized video image and sound presently being broadcast, and the video image and sound several seconds or several minutes before them can be displayed. Therefore, the viewer can enjoy watching the video image and sound that were missed several minutes ago simultaneously with a real-time broadcasting.

### BRIEF DESCRIPTION OF THE DRAWINGS

FIG. 1 is a block diagram showing a construction of the present invention, and

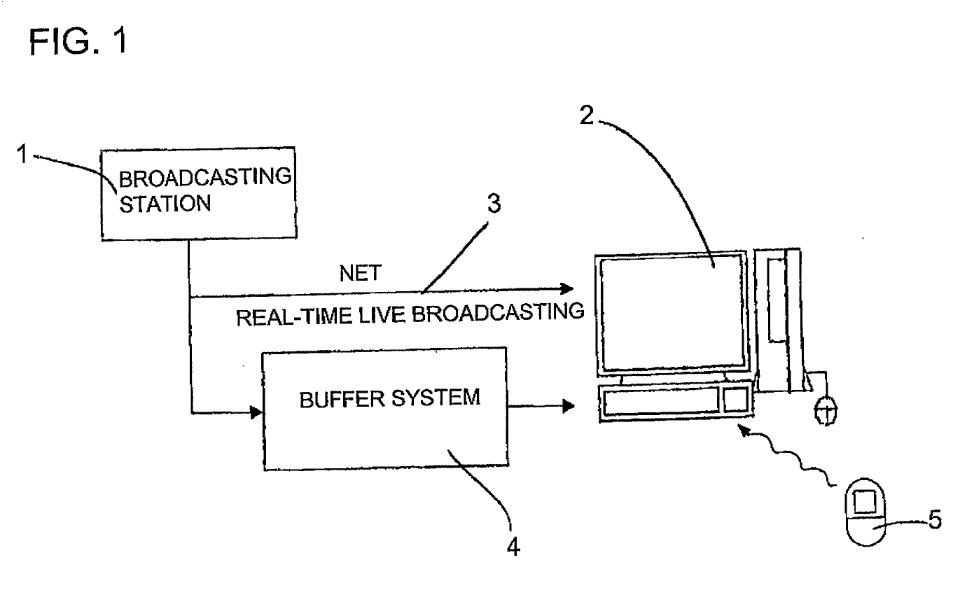

FIG. 2 is a block diagram showing a function of the present invention.

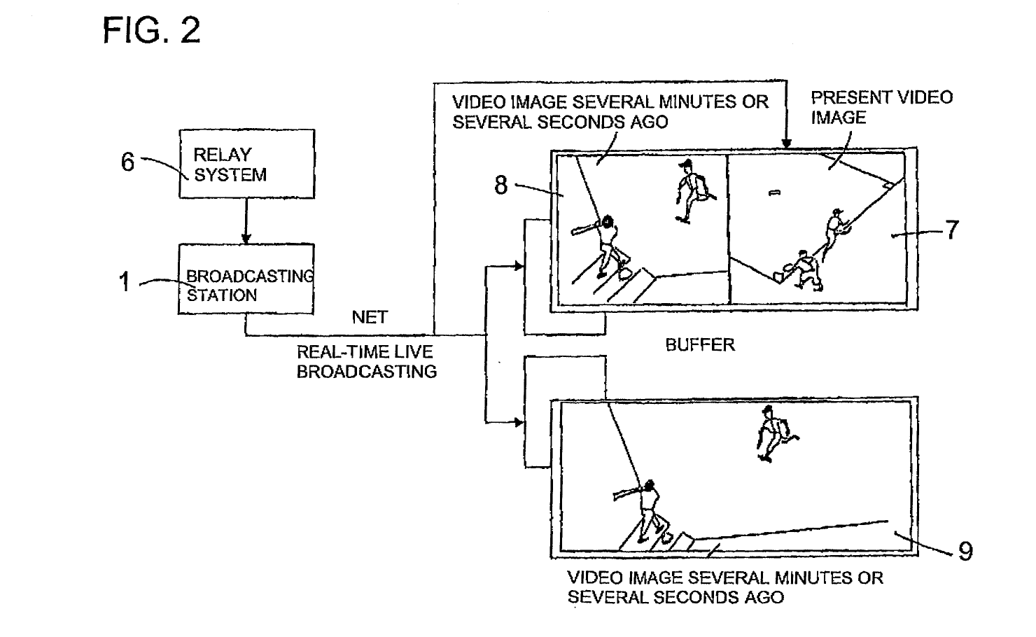

### LIST OF REFERENCE NUMERALS

1 . . . broadcasting station

2 . . . PC of a viewer

3 . . . network system

4 . . . backup system

5 . . . remote controller

6 . . . relay system

7 . . . present video image

8 . . . video image several seconds or several minutes ago of two video images

9 . . . video image several seconds or several minutes ago

What is claimed is:

1. A video image playback method in a digital TV image transmitting and receiving system, characterized in that a buffer system having a function of successively recording and erasing broadcast video images and sounds linked therewith by the second or by the minute while continuing an actual real-time broadcasting is provided in a network circuit, wherein an already broadcast video image and/or sound are reproduced by operating the buffer system.

2. A video image playback method in a digital TV image transmitting and receiving system, characterized in that a buffer system having a function of successively recording and erasing broadcast video images and sounds linked therewith by the second or by the minute while continuing an actual real-time broadcasting is provided in a network circuit, wherein a video image presently being broadcast and an already broadcast video image and/or sound are reproduced on two screens by operating the buffer system.
